(19) United States
(12) Patent Application Publication
(10) Pub. No.: US 2026/0175078 A1
(43) Pub. Date: Jun. 25, 2026

(54) PULL-UP BAR FOR DOORFRAME

(71) Applicant: ATFLEE INC., Seoul (KR)

(72) Inventor: TEOK SHIN PARK, Seoul (KR)

(21) Appl. No.: 19/127,574

(22) PCT Filed: Nov. 17, 2023
(86) PCT No.: PCT/KR2023/018599

§ 371 Date: May 6, 2025

(30) Foreign Application Priority Data
Dec. 15, 2022 (KR) 10-2022-0176131

(51) Int. Cl. A63B 23/12; A63B 1/00; A63B 21/16

(52) U.S. Cl. CPC A63B 23/1218; A63B 1/00; A63B 21/1627; A63B 2225/09

(57) ABSTRACT

A pull-up bar for a doorframe includes a first grip bar that includes a first screw bar, a first grasp bar and a first adapter, a second grip bar that is disposed to be vertically symmetrical to the first grip bar and includes a second screw bar, a second grasp bar, and a second adapter, and a support bar that is interposed between the first grip bar and the second grip bar such that both ends of the support bar are accommodated inside the first grasp bar and the second grasp bar, respectively, an inner circumferential surface of the support bar.

### BACKGROUND

### 1. Technical Field

The present invention relates to a pull-up bar for a doorframe, and more specifically, to a pull-up bar for a doorframe which has grasping portions which are exposed to have a constant length such that a user can easily grasp the grasping portions even when length adjustment of the pull-up bar is performed to fit the pull-up bar in a span of the doorframe.

### 2. Background Art

An increase in interest in health after the COVID-19 pandemic resulted in an increase in interest in “Home-tness” (home+fitness) meaning exercising in indoor space such as a home without restrictions of fine dust, weather, or the like. In this respect, a doorframe pull-up bar used by being simply fitted in a doorframe has gained popularity. Pull-up bar exercises can be called full body exercises in that even just hanging down from a pull-up bar can be effective in an increase in grip strength and posture correcting by adjusting overall balance of a body and not only can be effective in training of arm muscles, back muscles, and shoulder muscles but also can build core muscles depending on postures.

Doorframe pull-up bars in the related art are set up by a technique of fixing grasp bars inserted into both ends of a central bar, respectively, to doorframes. In order to insert the grasp bars, the central bar is formed to have a large diameter, and the grasp bars are formed to have a small diameter. Hence, grasping of the pull-up bars is performed in a way of grasping the grasp bars, and in a case where the grasp bars have a short projecting length due to a short span of a doorframe, there arises a problem of discomfort in that the hands touch the length adjusting nuts on the central bar side or fixing caps on the grasp bar side. In particular, in a case where the central bar is grasped to prevent hands from touching the length adjusting nuts or the fixing caps, it is inevitable to grasp narrower than a user's shoulder width, and thus there arise problems of not only being uncomfortable but also exercise effect being decreased.

In this respect, there is a demand for a doorframe pull-up bar having grasping portions which are exposed to have a constant length such that a user can easily grasp the grasping portions even when length adjustment of the pull-up bar is performed to fit the pull-up bar in a span of the doorframe. Related prior art includes Korean Patent Registration No. 10-1833668.

### SUMMARY

A technical object to be achieved by the present invention is to provide a pull-up bar for a doorframe which has grasping portions exposed to have a constant length such that a user can easily grasp the grasping portions even when length adjustment of the pull-up bar is performed to fit the pull-up bar in a span of the doorframe.

Technical objects of the present invention are not limited to the technical object described above, and the following description enables those skilled in the art to clearly understand the other undescribed technical objects.

According to an embodiment of the present invention to achieve the technical object, there is provided a pull-up bar for a doorframe including: a first grip bar that includes a first screw bar having a first thread with a helix formed in a first helix direction on an outer circumferential surface of the first screw bar, a first grasp bar which accommodates the first screw bar in a length direction inside, and a first adapter which is coupled to an end portion of the first grasp bar and fixes the first screw bar to the first grasp bar in a cantilever shape; a second grip bar that is disposed to be vertically symmetrical to the first grip bar and includes a second screw bar having a second thread with a helix formed in a second helix direction opposite to the first helix direction on an outer circumferential surface of the second screw bar, a second grasp bar which accommodates the second screw bar in a length direction inside, and a second adapter which is coupled to an end portion of the second grasp bar and fixes the second screw bar to the second grasp bar in a cantilever shape; and a support bar that is interposed between the first grip bar and the second grip bar such that both ends of the support bar are accommodated inside the first grasp bar and the second grasp bar, respectively, an inner circumferential surface of the support bar on one side which is accommodated in the first grasp bar is coupled to a first nut block to which the first screw bar is screw-coupled, and an inner circumferential surface of the support bar on the other side which is accommodated in the second grasp bar is coupled to a second nut block to which the second screw bar is screw-coupled. Rotation of the support bar causes the first grip bar and the second grip bar to be moved in a length direction of the support bar and come into close contact with or be detached from the doorframe.

The first grasp bar and the second grasp bar may have a round bar shape having an equal diameter, and the support bar may have a round bar shape having an outer circumferential surface which comes into close contact with inner circumferential surfaces of the first grasp bar and the second grasp bar.

A length of the support bar exposed between the first grasp bar and the second grasp bar may be shorter than a length of each of the first grasp bar and the second grasp bar.

The pull-up bar for a doorframe may further include a handle tube that covers an outer circumferential surface of the support bar at a center and is in close contact with and is fixed to the outer circumferential surface.

The handle tube may have a length longer than a total length of the support bar exposed outside.

The handle tube may have an outer diameter larger than outer diameters of the first grasp bar and the second grasp bar.

The pull-up bar for a doorframe may further include a first fixing pin that penetrates and fixes the first adapter and the first screw bar in a diametric direction, and a second fixing pin that penetrates and fixes the second adapter and the second screw bar in a diametric direction.

The pull-up bar for a doorframe may further include a first fixing cap and a second fixing cap that are coupled to outer sides of the first adapter and the second adapter, respectively, and come into close contact with the doorframe. The first fixing cap and the second fixing cap may have respective caved grooves into which the first adapter and the second adapter are inserted, respectively, the caved grooves being disposed eccentrically on upper sides of the first and second fixing caps.

A pull-up bar for a doorframe according to the embodiment of the present invention is formed in a structure in which both ends of a support bar positioned at the center are accommodated inside a first grasp bar and a second grasp bar, respectively, such that grasping portions are always exposed to have a constant length even when length adjustment is performed to fit the pull-up bar in a span of a doorframe. Hence, a user can avoid gripping the support bar in a length smaller than the user's shoulder width, and diameters of the first grasp bar and the second grasp bar are larger than those in the related art such that the user can avoid grasping the grasp bars in a finger-into-palm manner, and thus users having various physiques can easily grasp the grasp bars and do exercise. In particular, since the support bar screw-coupled to both the first grasp bar and the second grasp bar is not grasped, the support bar can be prevented from unintentionally rotating, and thus the present invention is characterized in that the pull-up bar can be prevented from being detached from the doorframe due to a change in length by movement of the first grasp bar and the second grasp bar.

### BRIEF DESCRIPTION OF THE DRAWINGS

FIG. 1 is a view illustrating a use state of a pull-up bar for a doorframe according to an embodiment of the present invention.

FIG. 2 is an exploded perspective view of the pull-up bar for a doorframe.

FIG. 3 is a longitudinal-sectional view illustrating the pull-up bar for a doorframe in FIG. 2 which is cut in a longitudinal direction.

FIG. 4 is an enlarged longitudinal-sectional view of a part of the pull-up bar for a doorframe.

FIGS. 5 and 6 are operational views for describing movement of the pull-up bar for a doorframe.

### DETAILED DESCRIPTION

Advantages and features, and methods for achieving the advantages and the features of the present invention are to be clarified with reference to the accompanying drawings and the embodiments which will be described in detail. However, the present invention is not limited to the embodiments disclosed hereinafter but can be realized in various different examples, and the exemplary embodiments are only provided to make the disclosure of the present invention complete and fully inform a person with ordinary skill in the art to which the present invention pertains of the scope of the invention, and the present invention is defined only by the scope of the claims. The same reference numerals represent the same configurational elements throughout the entire specification.

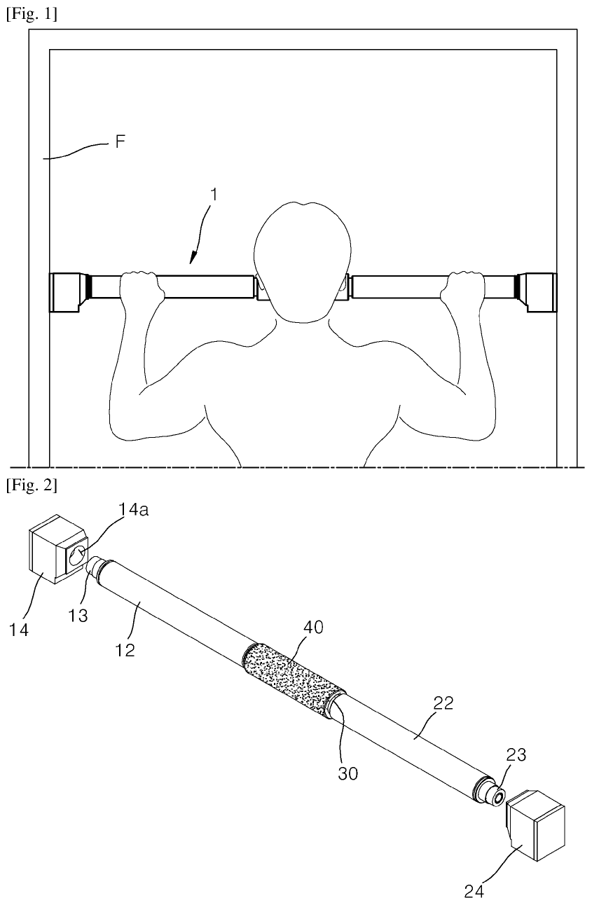

Hereinafter, a pull-up bar for a doorframe according to an embodiment of the present invention will be described in detail with reference to FIGS. 1 to 6.

FIG. 1 is a view illustrating a use state of a pull-up bar for a doorframe according to an embodiment of the present invention.

A pull-up bar 1 for a doorframe according to the embodiment of the present invention is formed in a structure in which both ends of a support bar (refer to 30 in FIG. 2) positioned at the center are accommodated inside a first grasp bar (refer to 12 in FIG. 2) and a second grasp bar (refer to 22 in FIG. 2), respectively, such that grasping portions are always exposed to have a constant length even when length adjustment is performed to fit the pull-up bar in a span of a doorframe F. Hence, a user can avoid gripping the support bar 30 in a length smaller than the user's shoulder width, and diameters of the first grasp bar 12 and the second grasp bar 22 are larger than those in the related art such that the user can avoid grasping the grasp bars in a finger-into-palm manner, and thus users having various physiques can easily grasp the grasp bars and do exercise. In particular, since the support bar 30 screw-coupled to both the first grasp bar 12 and the second grasp bar 22 is not grasped, the support bar 30 can be prevented from unintentionally rotating, and thus the present invention is characterized in that the pull-up bar can be prevented from being detached from the doorframe F due to a change in length by movement of the first grasp bar 12 and the second grasp bar 22.

Hereinafter, the pull-up bar 1 for a doorframe will be described in detail with reference to FIGS. 2 to 4.

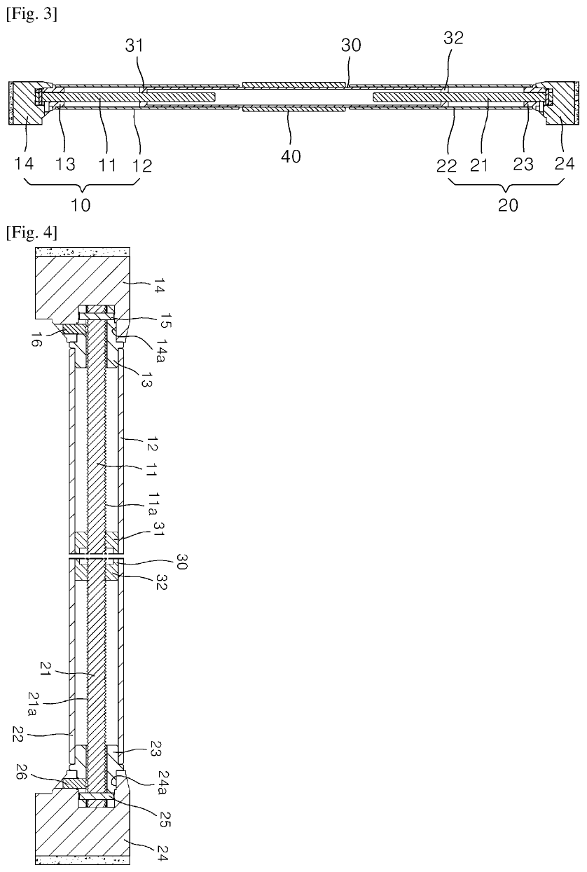

FIG. 2 is an exploded perspective view of the pull-up bar for a doorframe, FIG. 3 is a longitudinal-sectional view illustrating the pull-up bar for a doorframe in FIG. 2 which is cut in a longitudinal direction, and FIG. 4 is an enlarged longitudinal-sectional view of a part of the pull-up bar for a doorframe.

The pull-up bar 1 for a doorframe according to the present invention includes a first grip bar 10, a second grip bar 20, and the support bar 30.

The first grip bar 10 is a portion on one side which is grasped by a user and includes a first screw bar 11, the first grasp bar 12, and a first adapter 13.

The first screw bar 11 is a metal member formed in a bar shape having a constant length and has a first thread 11a with a helix formed in a first helix direction on an outer circumferential surface thereof. The first screw bar 11 is accommodated inside the first grasp bar 12. The first grasp bar 12 is a metal member formed in a round bar shape having a hollow center in a length direction thereof and accommodates the first screw bar 11 inside in the length direction. Since the first screw bar 11 is formed to have a diameter smaller than that of the first grasp bar 12, the first screw bar 11 and the first grasp bar 12 can be separated from each other. The first grasp bar 12 can be wrapped by a tube (not illustrated) on an outer circumferential surface thereof to improve a grip feeling and prevent slipping, and the first screw bar 11 can be fixed to the first grasp bar 12 by the first adapter 13. The first adapter 13 fixes the first screw bar 11 to the first grasp bar 12 in a cantilever shape and thereby can support one side of the first screw bar 11 by being coupled to an end portion of the first grasp bar 12 through welding or fitting of projections into depressions. More specifically, the first screw bar 11 penetrates the center of the first adapter 13, and the first adapter 13 and the first screw bar 11 can have respective through-holes (without a reference numeral) penetrating in a diameter direction of the first screw bar 11. The first adapter 13 and the first screw bar 11 can be fixed to each other when a first fixing pin 15 is inserted into the overlapped through-holes. The first fixing pin 15 is a spring pin having a cylindrical shape with slits formed in a length direction thereof, and intervals between the slits are reduced when the first fixing pin is inserted into the through-holes such that the first fixing pin can be smoothly inserted into the through-holes. When the first fixing pin is inserted into the through-holes, the intervals between the slits are restored to original states thereof, and thus firm fixing can be achieved. The spring-shaped first fixing pin is fixed by penetrating the first adapter 13 and the first screw bar 11, and thereby a gap is formed between the first adapter 13 and the first screw bar 11 such that the first screw bar 11 can be automatically centered in the first grasp bar 12. In a case where the first adapter 13 and the first screw bar 11 are fixed by welding, the first screw bar 11 is not centered in the first grasp bar 12 if the first screw bar 11 does not precisely maintain a horizontal state. Consequently, it is not possible to smoothly screw-couple the first screw bar 11 to a first nut block 31 to be described below. In the present invention, since the spring-shaped first fixing pin 15 fixes the first adapter 13 and the first screw bar 11 and simultaneously forms a gap therebetween, the first screw bar 11 is automatically centered in the first grasp bar, and thus the first screw bar 11 and the first nut block 31 can be easily screw-coupled to each other. A first fixing cap 14 is coupled to an outer side of the first adapter 13. The first fixing cap 14 comes into close contact with the doorframe F, and thereby a caved groove 14a into which the first adapter 13 is inserted can be formed eccentrically on an upper side thereof. Since an outer surface of the first fixing cap 14 which comes into contact with the doorframe F is coupled to a non-slip pad (without a reference numeral) or has projections and depressions, the first fixing cap can easily come into contact with the doorframe F without slipping from the doorframe. The first fixing cap 14 and the first adapter 13 can be fixed to each other by a first connection pin 16, and the first connection pin 16 can be inserted by penetrating one side of each of the first fixing cap 14 and the first adapter 13.

The second grip bar 20 is a portion on the other side which is grasped by a user, includes a second screw bar 21, the second grasp bar 22, and a second adapter 23, and is disposed to be vertically symmetrical to the first grip bar 10.

The second screw bar 21 is a metal member formed in a bar shape having a constant length and has a second thread 21a with a helix formed in a second helix direction opposite to the first helix direction on an outer circumferential surface thereof. The second screw bar 21 is accommodated inside the second grasp bar 22. The second grasp bar 22 is a metal member formed in a round bar shape having a hollow center in a length direction thereof and having the same diameter as that of the first grasp bar 12 and accommodates the second screw bar 21 inside in the length direction. Since the second screw bar 21 is formed to have a diameter smaller than that of the second grasp bar 22, the second screw bar 21 and the second grasp bar 22 can be separated from each other. The second grasp bar 22 can be wrapped by a tube (not illustrated) on an outer circumferential surface thereof to improve a grip feeling and prevent slipping, and the second screw bar 21 can be fixed to the second grasp bar 22 by the second adapter 23. The second adapter 23 fixes the second screw bar 21 to the second grasp bar 22 in a cantilever shape and thereby can support one side of the second screw bar 21 by being coupled to an end portion of the second grasp bar 22 through welding or fitting of projections into depressions. More specifically, the second screw bar 21 penetrates the center of the second adapter 23, and the second adapter 23 and the second screw bar 21 can have respective through-holes (without a reference numeral) penetrating in a diameter direction of the second screw bar 21. The second adapter 23 and the second screw bar 21 can be fixed to each other when a second fixing pin 25 is inserted into the overlapped through-holes. The second fixing pin 25 is a spring pin having a cylindrical shape with slits formed in a length direction thereof, and intervals between the slits are reduced when the second fixing pin is inserted into the through-holes such that the second fixing pin can be smoothly inserted into the through-holes. When the second fixing pin is inserted into the through-holes, the intervals between the slits are restored to original states thereof, and thus firm fixing can be achieved. The spring-shaped second fixing pin 25 is fixed by penetrating the second adapter 23 and the second screw bar 21, and thereby a gap is formed between the second adapter 23 and the second screw bar 21 such that the second screw bar 21 can be automatically centered in the second grasp bar 22. In a case where the second adapter 23 and the second screw bar 21 are fixed by welding, the second screw bar 21 is not centered in the second grasp bar 22 if the second screw bar 21 does not precisely maintain a horizontal state. Consequently, it is not possible to smoothly screw-couple the second screw bar 21 to a second nut block 32 to be described below. In the present invention, since the spring-shaped second fixing pin 25 fixes the second adapter 23 and the second screw bar 21 and simultaneously forms a gap therebetween, the second screw bar 21 is automatically centered in the second grasp bar, and thus the second screw bar 21 and the second nut block 32 can be easily screw-coupled to each other. A second fixing cap 24 is coupled to an outer side of the second adapter 23. The second fixing cap 24 comes into close contact with the doorframe F, and thereby a caved groove 24a into which the second adapter 23 is inserted can be formed eccentrically on an upper side thereof. The caved grooves 14a and 24a of the first fixing cap 14 and the second fixing cap 24 are both formed eccentrically on the upper side, and thereby an area that can support a load from a lower side of the first adapter 13 and the second adapter 23 can be increased such that a more stable structure can be formed. Since an outer surface of the second fixing cap 24 which comes into contact with the doorframe F is coupled to a non-slip pad (without a reference numeral) or has projections and depressions, the second fixing cap can easily come into contact with the doorframe F without slipping from the doorframe. The second fixing cap 24 and the second adapter 23 can be fixed to each other by a second connection pin 26, and the second connection pin 26 can be inserted by penetrating one side of each of the second fixing cap 24 and the second adapter 23.

The support bar 30 can be interposed between the first grip bar 10 and the second grip bar 20. The support bar 30 is a metal member having a round bar shape in which the center of the support bar is penetrated in a length direction such that the first screw bar 11 and the second screw bar 21 can be accommodated, and both ends of the support bar can be accommodated in the first grasp bar 12 and the second grasp bar 22, respectively such that an outer circumferential surface of the support bar can come into close contact with the first grasp bar 12 and the second grasp bar 22. The first nut block 31 to which the first screw bar 11 is screw-coupled is coupled to or is formed integrally to an inner circumferential surface of the support bar 30 on one side which is accommodated in the first grasp bar 12, and the second nut block 32 to which the second screw bar 21 is screw-coupled is coupled to or is formed integrally to an inner circumferential surface of the support bar on the other side which is accommodated in the second grasp bar 22. Hence, rotation of the support bar 30 causes the first grip bar 10 and the second grip bar 20 to be moved in the length direction of the support bar 30 and come into close contact with or be detached from the doorframe F. For example, when the support bar 30 rotates in one direction, for example, counterclockwise, the first grip bar 10 and the second grip bar 20 can be moved toward an outer side of the support bar 30 to come into close contact with the doorframe F due to screw-coupling of the first screw bar 11 to the first nut block 31 and the second screw bar 21 to the second nut block 32. Conversely, when the support bar 30 rotates in the other direction, for example, clockwise, the first grip bar 10 and the second grip bar 20 can be moved toward the center of the support bar 30 to be detached from the doorframe F due to screw-coupling of the first screw bar 11 to the first nut block 31 and the second screw bar 21 to the second nut block 32.

A length of the support bar 30 exposed between the first grasp bar 12 and the second grasp bar 22 can be shorter than a length of each of the first grasp bar 12 and the second grasp bar 22. The length of the support bar 30 exposed between the first grasp bar 12 and the second grasp bar 22 is shorter than the length of each of the first grasp bar 12 and the second grasp bar 22, and thereby an area in which each of the first grasp bar 12 and the second grasp bar 22 come into contact with the support bar 30 is increased such that the first grasp bar 12 and the second grasp bar 22 can be prevented from being separated from the support bar 30. In addition, even when a user grasps the first grasp bar 12 and the second grasp bar 22 and hangs down therefrom, a load is distributed to the first grasp bar 12, the second grasp bar 22, and the support bar 30, and thus structural deformation can be prevented.

An outer circumferential surface of the center of the support bar 30, and more specifically, the center exposed between the first grasp bar 12 and the second grasp bar 22 can be wrapped by a handle tube 40 made of a urethane material to improve a grip feeling and prevent slipping. The handle tube 40 has an outer diameter larger than an outer diameter of each of the first grasp bar 12 and the second grasp bar 22 and thus can come into close contact with and can be fixed to the outer circumferential surface of the support bar 30 at the center while wrapping the outer circumferential surface thereof. The handle tube 40 can have a length longer than a total length of the support bar 30 exposed outside. The length of the handle tube 40 is set to be longer than the total length of the support bar 30 exposed outside, and thereby direct contact of a user with the support bar 30 made of metal can be minimized such that usability is increased, and the support bar 30 can be prevented from being decolored and corroded by repeated contact with sweat, foreign substances, or the like.

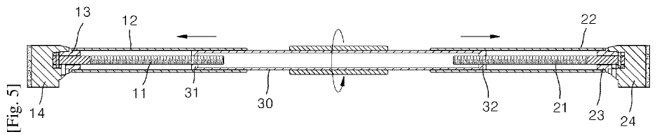

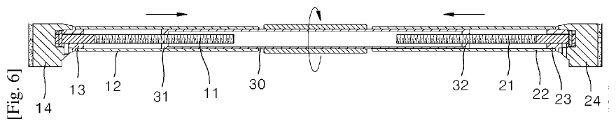

Hereinafter, movement of the pull-up bar 1 for a doorframe will be described in detail with reference to FIGS. 5 and 6.

FIGS. 5 and 6 are operational views for describing movement of the pull-up bar for a doorframe.

The pull-up bar 1 for a doorframe according to the present invention is formed in the structure in which both ends of the support bar 30 positioned at the center are accommodated inside the first grasp bar 12 and the second grasp bar 22, respectively, such that grasping portions are always exposed to have a constant length even when length adjustment is performed to fit the pull-up bar in the span of the doorframe F. Hence, a user can avoid gripping the support bar 30 in a length smaller than the user's shoulder width, and diameters of the first grasp bar 12 and the second grasp bar 22 are larger than those in the related art such that the user can avoid grasping the grasp bars in a finger-into-palm manner, and thus users having various physiques can easily grasp the grasp bars and do exercise. In particular, since the support bar 30 screw-coupled to both the first grasp bar 12 and the second grasp bar 22 is not grasped, the support bar 30 can be prevented from unintentionally rotating, and thus the pull-up bar can be prevented from being detached from the doorframe F due to a change in length by movement of the first grasp bar 12 and the second grasp bar 22.

FIG. 5 is a view for describing movement to increase a length of the pull-up bar for a doorframe, and FIG. 6 is a view for describing movement to decrease a length of the pull-up bar for a doorframe.

First, with reference to FIG. 5, the user can rotate the support bar 30 in one direction, for example, counterclockwise, to move the first grip bar 10 and the second grip bar 20 toward an outer side of the support bar 30. More specifically, when the support bar 30 is rotated in the counterclockwise direction, the first screw bar 11 and the second screw bar 21 screw-coupled to the first nut block 31 and the second nut block 32, respectively, are moved toward the outer side of the support bar 30, and thus the first grasp bar 12 fixed to the first screw bar 11 by the first adapter 13 and the second grasp bar 22 fixed to the second screw bar 21 by the second adapter 23 can be both moved toward the outer side of the support bar 30. When the first grasp bar 12 and the second grasp bar 22 are moved toward the outer side of the support bar 30, a total length of the pull-up bar is increased, and thus the first fixing cap 14 and the second fixing cap 24 fixed to the first adapter 13 and the second adapter 23, respectively, can come into close contact with the doorframe F.

Conversely, with reference to FIG. 6, the user can rotate the support bar 30 in the other direction, for example, clockwise, to move the first grip bar 10 and the second grip bar 20 toward the center side of the support bar 30. More specifically, when the support bar 30 is rotated in the clockwise direction, the first screw bar 11 and the second screw bar 21 screw-coupled to the first nut block 31 and the second nut block 32, respectively, are moved toward the inner side of the support bar 30, and thus the first grasp bar 12 fixed to the first screw bar 11 by the first adapter 13 and the second grasp bar 22 fixed to the second screw bar 21 by the second adapter 23 can be both moved toward the center side of the support bar 30. When the first grasp bar 12 and the second grasp bar 22 are moved toward the center side of the support bar 30, a total length of the pull-up bar is decreased, and thus the first fixing cap 14 and the second fixing cap 24 fixed to the first adapter 13 and the second adapter 23, respectively, can be detached from the doorframe F.

As described above, the embodiments of the present invention are described with reference to the drawings; however, it is possible for a person with ordinary skill in the art to which the invention pertains to understand that the present invention can be realized in other embodiments without changing the technical ideas or essential features. Hence, the embodiments described above are to be understood as examples in every aspect and as examples that do not limit the present invention.

According to the present invention, a pull-up bar has a structure in which both ends of a support bar positioned at the center are accommodated inside a first grasp bar and a second grasp bar, respectively, such that grasping portions are always exposed to have a constant length even when length adjustment is performed to fit the pull-up bar in a span of a doorframe. Hence, a user can avoid gripping the support bar in a length smaller than the user's shoulder width, and diameters of the first grasp bar and the second grasp bar are larger than those in the related art such that the user can avoid grasping the grasp bars in a finger-into-palm manner, and thus users having various physiques can easily grasp the grasp bars and do exercise. In particular, since the support bar screw-coupled to both the first grasp bar and the second grasp bar is not grasped, the support bar can be prevented from unintentionally rotating, and thus the pull-up bar can be prevented from being detached from the doorframe due to a change in length by movement of the first grasp bar and the second grasp bar.

While the present invention has been described with respect to the specific embodiments, it will be apparent to those skilled in the art that various changes and modifications may be made without departing from the spirit and scope of the invention as defined in the following claims.

The present invention relates to exercise equipment for improving human health and has high industrial applicability.

1: A pull-up bar for a doorframe, comprising:
a first grip bar comprising a first screw bar having a first thread with a helix formed in a first helix direction on an outer circumferential surface of the first screw bar, a first grasp bar configured to accommodate the first screw bar in a length direction inside, and a first adapter coupled to an end portion of the first grasp bar and configured to fix the first screw bar to the first grasp bar in a cantilever shape;
a second grip bar disposed to be vertically symmetrical to the first grip bar, the second grip bar comprising a second screw bar having a second thread with a helix formed in a second helix direction opposite to the first helix direction on an outer circumferential surface of the second screw bar, a second grasp bar configured to accommodate the second screw bar in a length direction inside, and a second adapter coupled to an end portion of the second grasp bar and configured to fix the second screw bar to the second grasp bar in a cantilever shape; and
a support bar interposed between the first grip bar and the second grip bar such that both ends of the support bar are accommodated inside the first grasp bar and the second grasp bar, respectively, an inner circumferential surface of the support bar on one side which is accommodated in the first grasp bar is coupled to a first nut block to which the first screw bar is screw-coupled, and an inner circumferential surface of the support bar on the other side which is accommodated in the second grasp bar is coupled to a second nut block to which the second screw bar is screw-coupled,
wherein rotation of the support bar is configured to cause the first grip bar and the second grip bar to be moved in a length direction of the support bar and come into close contact with or be detached from the doorframe.

2: The pull-up bar for a doorframe according to claim 1,
wherein the first grasp bar and the second grasp bar have a round bar shape having an equal diameter, and
wherein the support bar has a round bar shape having an outer circumferential surface which comes into close contact with inner circumferential surfaces of the first grasp bar and the second grasp bar.

3: The pull-up bar for a doorframe according to claim 2,
wherein a length of the support bar exposed between the first grasp bar and the second grasp bar is shorter than a length of each of the first grasp bar and the second grasp bar.

4: The pull-up bar for a doorframe according to claim 2, further comprising:
a handle tube that covers an outer circumferential surface of the support bar at a center and is in close contact with and is fixed to the outer circumferential surface.

5: The pull-up bar for a doorframe according to claim 4,
wherein the handle tube has a length longer than a total length of the support bar exposed outside.

6: The pull-up bar for a doorframe according to claim 5,
wherein the handle tube has an outer diameter larger than outer diameters of the first grasp bar and the second grasp bar.

7: The pull-up bar for a doorframe according to claim 1, further comprising:
a first fixing pin that penetrates and fixes the first adapter and the first screw bar in a diametric direction, and
a second fixing pin that penetrates and fixes the second adapter and the second screw bar in a diametric direction.

8: The pull-up bar for a doorframe according to claim 1, further comprising:
a first fixing cap and a second fixing cap that are coupled to outer sides of the first adapter and the second adapter, respectively, and come into close contact with the doorframe,
wherein the first fixing cap and the second fixing cap have respective caved grooves into which the first adapter and the second adapter are inserted, respectively, the caved grooves being disposed eccentrically on upper sides of the first and second fixing caps.
